(19) United States
(12) Patent Application Publication
(10) Pub. No.: US 2013/0033189 A1
(43) Pub. Date: Feb. 7, 2013

(54) DIMMING CONTROL DEVICE, LED DRIVING DEVICE, AND DIMMING CONTROL METHOD

(71) Applicants: Jung Eui Park, Gyeonggi-do (KR); Jae Shin Lee, Gyeonggi-do (KR); Jung Sun Kwon, Gyeonggi-do (KR); Bo Hyun Hwang, Gyeonggi-do (KR); Seung Kon Kong, Gyeonggi-do (KR)

(72) Inventors: Jung Eui Park, Gyeonggi-do (KR); Jae Shin Lee, Gyeonggi-do (KR); Jung Sun Kwon, Gyeonggi-do (KR); Bo Hyun Hwang, Gyeonggi-do (KR); Seung Kon Kong, Gyeonggi-do (KR)

(21) Appl. No.: 13/418,188

(22) Filed: Mar. 12, 2012

(30) Foreign Application Priority Data
Aug. 2, 2011 (KR) 10-2011-0077122

(51) Int. Cl. H05B 37/02

(52) U.S. Cl. 315/209 R

(57) ABSTRACT

The present invention relates to a dimming control device, an LED driving device, and a dimming control method. In accordance with an embodiment of the present invention, a dimming control device including: a PWM signal generating unit for generating a PWM signal from a reference signal and an input voltage; a signal compensating unit for compensating the PWM signal output from the PWM signal generating unit using an internal clock signal; and a synchronization unit for synchronizing the compensated signal with an external clock signal to output a synchronized PWM control signal for dimming control is proposed. Further, an LED driving device and a dimming control method are proposed.

### CROSS-REFERENCE TO RELATED APPLICATIONS

Claim and incorporate by reference domestic priority application and foreign priority application as follows:

“CROSS REFERENCE TO RELATED APPLICATION This application claims the benefit under 35 U.S.C. Section 119 of Korean Patent Application Serial No. 10-2011-0077122, entitled filed Aug. 2, 2011, which is hereby incorporated by reference in its entirety into this application.”

### BACKGROUND OF THE INVENTION

1. Field of the Invention

The present invention relates to a dimming control device, an LED driving device, and a dimming control method, and more particularly, to a dimming control device, an LED driving device, and a dimming control method that are capable of synchronizing with an external clock without using a PLL.

2. Description of the Related Art

A PWM control method is generally used as a method of controlling brightness of an LED. When the LED is turned on and off at above a certain frequency, it seems to human eyes that light is continuously turned on. The higher a ratio of an ON interval within one cycle of an ON/OFF signal, the higher the brightness of the LED is. Therefore, the LED is controlled to be turned on and off by a method in which a PWM signal with a duty ratio adjusted to the desired brightness is generated and provided to a switching means. Since the brightness of the LED can be adjusted by using the PWM signal, that is, the duty ratio, a PWM signal generating device for providing the duty ratio suitable for the desired brightness is separately needed.

In the prior art, although a PWM signal with 0% to 100% of a high interval within one cycle is separately generated and applied to a driving circuit from outside, recently, in order to simplify this, an internal PWM method, in which the PWM signal generating device is embedded in the driving circuit, has been used. This method generates a reference waveform inside and compares the generated reference waveform with an input DC voltage to generate a PWM signal. At this time, a duty ratio is determined according to a size of the DC input voltage.

In case of this conventional method, a PLL is mainly used to prevent a phenomenon that a screen falls when the generated PWM signal is not synchronized with an external image signal, what is called a waterfall phenomenon. However, when the PLL is used, there exists a transient state, which is a state proceeding from an initial state (when the PWM signal is not synchronized with an external clock) to a normal state (when the PWM signal is synchronized with the external clock). In this transient state, since frequency and duty of the PWM signal are changed, a flickering phenomenon of the LED occurs when the LED is driven.

### SUMMARY OF THE INVENTION

When using a PLL as in the prior art, there exists a transient state, and an additional circuit, which prevents driving of an LED, has been needed in order to prevent a flickering phenomenon in this transient state.

In addition to this, according to a conventional method, there are several problems such as errors of an output PWM signal or jitter of rising or/and falling edges of the PWM signal when noise occurs in a triangle wave as a reference waveform or an input voltage. When these problems occur, brightness of the LED is affected since a duty value is continuously changed.

The present invention has been invented in order to overcome the above-described problems and it is, therefore, an object of the present invention to provide a dimming control device, an LED driving device, and a dimming control method that are capable of preventing problems occurring when an internal PWM signal is generated, for example, a malfunction due to clock jitter or/and noise interferences and synchronizing with an external clock without using a PLL mainly used in the prior art.

In accordance with a first embodiment of the present invention to achieve the object, there is provided a dimming control device including: a PWM signal generating unit for generating a pulse width modulation (PWM) signal from a reference signal and an input voltage; a signal compensating unit for compensating the PWM signal output from the PWM signal generating unit using an internal clock signal; and a synchronization unit for synchronizing the compensated signal with an external clock signal to output a synchronized PWM control signal for dimming control.

In accordance with another embodiment of the present invention, the signal compensating unit may generate a primary compensation signal by compensating the PWM signal using the internal clock signal and a secondary compensation signal by averaging duty ratios or up pulse durations of the primary compensation signal during preset cycles.

Further, in an embodiment, the signal compensating unit may generate the primary compensation signal by counting the number of clocks of the internal clock signal during a up pulse of the PWM signal, determining the up pulse as an effective clock pulse when the counted number is greater than or equal to a preset value, and removing the up pulse when the counted number is less than the preset value.

In accordance with another embodiment of the present invention, the PWM signal generating unit may generate the PWM signal by including a comparator for comparing the reference signal generated by a reference signal generating circuit and the input voltage.

In another embodiment, the reference signal may be a triangle or sawtooth wave voltage signal.

In accordance with a second embodiment of the present invention to achieve the object, there is provided an LED driving device including: a dimming control device according to one of the above-described embodiments; and a driving switch for performing a switching operation according to the PWM control signal output from the dimming control device and supplying power to an LED according to the switching operation.

In accordance with another embodiment, the LED driving device may be used in a backlight unit.

Further, in accordance with a third embodiment of the present invention to achieve the object, there is provided a dimming control method including: a PWM signal generating step of generating a PWM signal from a reference signal and an input voltage; a signal compensating step of compensating the generated PWM signal using an internal clock signal; and a synchronization step of synchronizing the compensated signal with an external clock signal to output a synchronized PWM control signal for dimming control.

In accordance with another embodiment of the present invention, the signal compensating step may include generating a primary compensation signal by compensating the PWM signal using the internal clock signal and generating a second compensation signal by averaging duty ratios or up pulse durations of the primary compensation signal during preset cycles.

Further, in accordance with an embodiment, in generating the primary compensation signal, the primary compensation signal may be generated by counting the number of clocks of the internal clock signal during a up pulse of the PWM signal, determining the up pulse as an effective clock pulse when the counted number is greater than or equal to a preset value, and removing the up pulse when the counted number is less than the preset value.

Further, in accordance with another embodiment of the present invention, in the PWM signal generating step, the PWM signal may be generated by comparing the reference signal generated by a reference signal generating circuit and the input voltage.

In another embodiment, the reference signal may be a triangle or sawtooth wave voltage signal, and in the PWM signal generating step, the PWM signal may be generated by generating the up pulse in an interval in which the reference signal is higher than the input voltage.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram roughly showing a dimming control device in accordance with an embodiment of the present invention;

FIG. 2 is a view roughly showing an LED driving device in accordance with another embodiment of the present invention;

FIG. 3 is a view illustrating problems occurring when an internal PWM signal is generated;

FIG. 4 is a view roughly showing an example of compensation and synchronization of a PWM signal in accordance with an embodiment of the present invention;

FIG. 5 is a flowchart roughly showing a dimming control method in accordance with yet another embodiment of the present invention; and

FIG. 6 is a flowchart roughly showing a dimming control method in accordance with still another embodiment of the present invention.

### DETAILED DESCRIPTION OF THE PREFERABLE EMBODIMENTS

Embodiments of the present invention to achieve the above-described objects will be described with reference to the accompanying drawings. In this description, the same elements are represented by the same reference numerals, and additional description which is repeated or limits interpretation of the meaning of the invention may be omitted.

Before the specific description, in this specification, when an element is referred to as being “connected” or “coupled” to another element, it can be “directly” connected or coupled to the other element or connected or coupled to the other element with another element interposed therebetween, unless it is referred to as being “directly connected” or “directly coupled” to the other element.

Although the singular form is used in this specification, it should be noted that the singular form can be used as the concept representing the plural form unless being contradictory to the concept of the invention or clearly interpreted otherwise.

It should be understood that the terms such as “having”, “including”, and “comprising” used herein do not preclude existence or addition of one or more other features or elements or combination thereof.

First, a dimming control device in accordance with a first embodiment of the present invention will be specifically described with reference to the drawings.

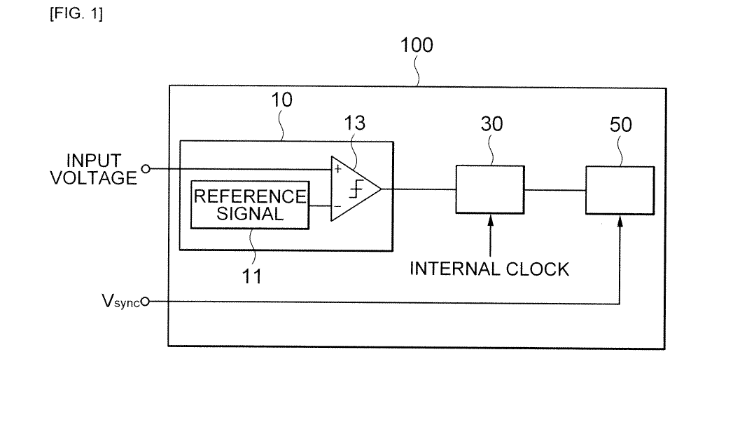

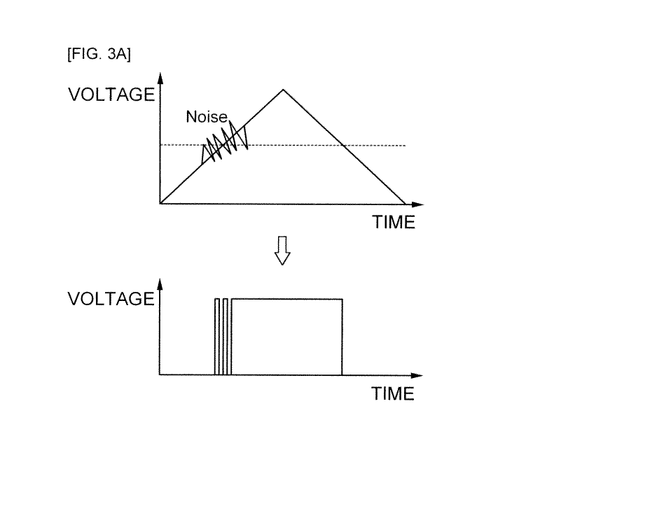

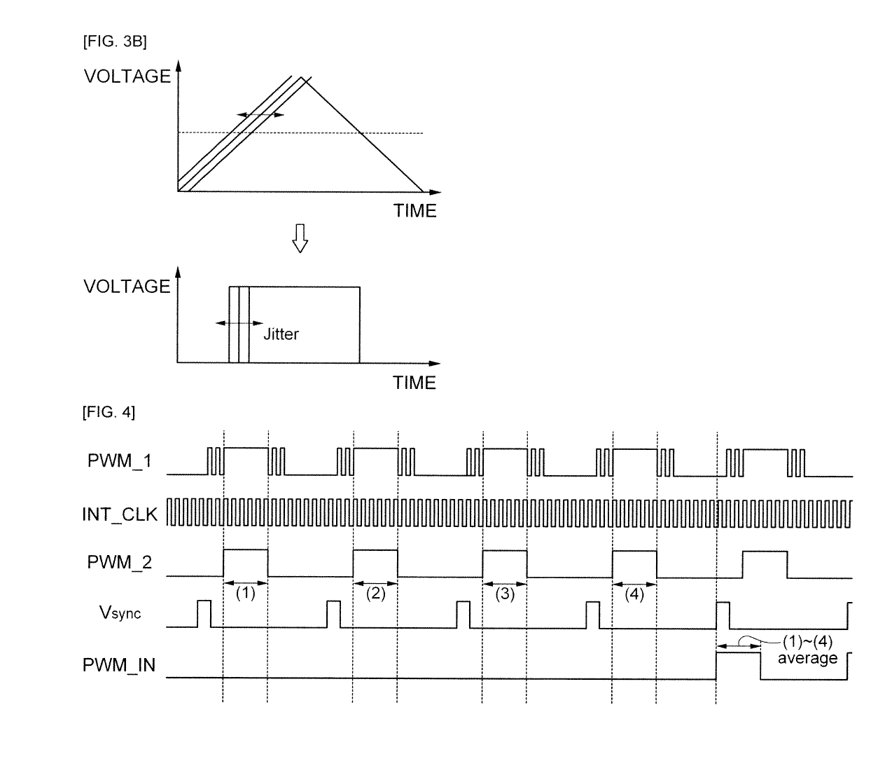

FIG. 1 is a block diagram roughly showing a dimming control device in accordance with an embodiment of the present invention. FIG. 3 is a view illustrating problems occurring when an internal PWM signal is generated. FIG. 4 is a view roughly showing an example of compensation and synchronization of a PWM signal in accordance with an embodiment of the present invention.

A dimming control device in accordance with an embodiment of the present invention will be described with reference to FIG. 1.

A dimming control device 100 in accordance with this embodiment includes a PWM signal generating unit 10, a signal compensating unit 30, and a synchronization unit 50.

At this time, the PWM signal generating unit 10 generates a pulse width modulation PWM signal from a reference signal and an input voltage. For example, the PWM signal can be generated by forming a portion of the reference signal, which exceeds the input voltage, as a up pulse and a portion of the reference signal, which does not reach the input voltage, as a falling pulse.

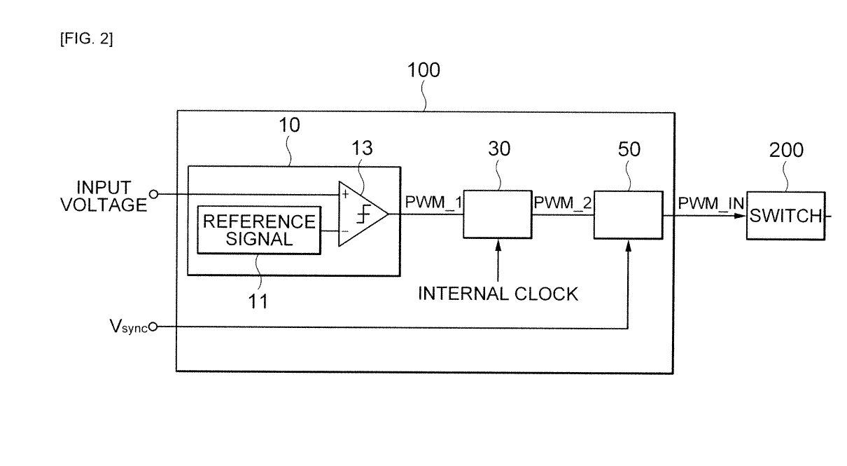

Another embodiment of the dimming control device 100 will be described with reference to FIG. 2. Referring to FIG. 2, the PWM signal generating unit 10 can generate the PWM signal by including a comparator 13 for comparing the reference signal generated by a reference signal generating circuit 11 and the input voltage. At this time, the reference signal generating circuit 11 may be provided inside the PWM signal generating unit 10. For example, the PWM signal can be generated by comparing the reference signal and the input voltage in the comparator 13 and generating the up pulse in an interval in which the reference signal voltage is higher than the input voltage. At this time, the reference signal may be a triangle wave, a sawtooth wave, or the like. Further, the input voltage may be a DC voltage. In addition to a triangle wave or a sawtooth wave, it is enough that the reference signal is a wave which can implement a pulse wave compared to the input voltage. Further, in addition to a DC voltage, it is also enough that the input voltage is an AC waveform voltage with small amplitude and very low frequency compared to the reference voltage. That is, it is enough that the input voltage is a reference which can generate a pulse wave by comparing a waveform of the reference signal through a comparator and so on.

The PWM signal generated by the PWM signal generating unit 10 may include several errors. For example, as shown in (a) of FIG. 3, a plurality of high frequency pulses may occur in the vicinity of rise or/and fall of a pulse wave due to influence of noise. Further, as shown in (b) of FIG. 3, pulse rise or/and fall portions of the generated PWM signal are rapidly advanced or delayed due to influence of jitter so that a rising clock interval may be expanded or reduced. It is necessary to remove these problems occurring when the PWM signal is generated.

Further, in an embodiment, the reference signal may be a triangle wave voltage signal or a sawtooth wave voltage signal. At this time, the PWM signal whose up pulse is formed in the interval in which the reference signal is higher than the input voltage can be generated. As an example, in FIG. 3, the reference signal is a triangle wave, and the input voltage is a DC voltage shown in dotted line.

Next, the signal compensating unit 30 will be described with reference to FIG. 1. In this embodiment, the signal compensating unit 30 compensates the PWM signal output from the PWM signal generating unit 10 by using an internal clock signal. The compensation in the signal compensating unit 10 is to compensate the above-described problems occurring when the PWM signal is generated. Although not shown, the internal clock signal is generated by an internal clock signal generating unit. For example, the compensation of the PWM signal using the internal clock signal is to compensate interferences such as noise, jitter, and so on. In embodiments of the present invention, the signal compensation of the signal compensating unit 30 may be performed by various methods. As an example, a compensation method using a digital circuit may be performed.

Specifically, another embodiment will be described with reference to FIG. 4. The signal compensating unit 30 can generate a primary compensation signal by compensating the PWM signal using the internal clock signal and a secondary compensation signal by averaging duty ratios or up pulse (high interval) durations during preset cycles. Distortion of the PWM signal may be primarily removed by using an internal clock INT_CLK. The primary compensation signal, which is generated by compensating the PWM signal using the internal clock signal, may be, for example, a compensation signal generated by removing noise included in the PWM signal. Referring to FIG. 4, the PWM signal PWM_1 generated by the PWM signal generating unit 10 is shown. The PWM signal PWM_1 shows high frequency pulses in the vicinity of pulse rise or/and fall due to noise interference and so on, and it is necessary to remove the high frequency noises due to this noise interference.

At this time, the high frequency pulses in the vicinity of the pulse rise or/and fall of the PWM signal PWM_1 can be removed by using the internal clock signal INT_CLK shown in FIG. 4. Specifically, in another embodiment, the signal compensating unit 30 can generate the primary compensation signal by counting the number of clocks of the internal clock signal (refer to INT_CLK of FIG. 4) during the up pulse of the PWM signal (refer to PWM_1 of FIG. 4), determining the up pulse as an effective clock pulse when the counted number is greater than or equal to a preset value, and removing the up pulse when the counted number is less than the preset value. At this time, the internal clock signal INT_CLK uses a frequency much higher than that of the generated PWM signal or the reference signal so that a sufficient number of internal clocks can be counted during the up pulse (high interval) of the PWM signal. Accordingly, it is possible to obtain a PWM_2 signal of FIG. 4 as the primary compensation signal by removing the high frequency pulses in the vicinity of the pulse rise or/and fall of PWM_1 and using a up pulse interval of the PWM_1 signal, in which the count value of the internal clock signal INT_CLK is more than the preset value, as an effective clock pulse (high interval). Even though the high frequency pulses due to noise interference and so on are removed, the up pulse interval may not be uniform due to jitter interference and so on.

Further, at this time, the signal compensating unit 30 can generate the secondary compensation signal by averaging the duty ratio or the up pulse (high interval) duration of the primary compensation signal during preset cycles. Referring to FIG. 4, the secondary compensation signal can be generated by averaging the up pulse durations or the duty ratios of the preceding four PWM_2 pulses. At this time, the duty ratio may be represented as the up pulse duration with respect to a cycle (T) time. It is possible to overcome problems due to jitter interference and so on in the vicinity of the pulse rise or/and fall by averaging the duty ratios or the up pulse durations of the PWM_2 signal of FIG. 4. In an example, since the cycle can be changed due to jitter interference and so on, the secondary compensation signal is generated by averaging the up pulse duration of the PWM_2 signal. The preset cycle number for averaging the duty ratios or the up pulse durations of the PWM_2 signal as the primary compensation signal may be changed according to embodiments. In an example, it may be determined in the range of about 3 to 5 cycles. Since the cycle time required for this averaging is just about 300 ms, it is much shorter than the case that a delay time for preventing flickering in a transient state lasts to seconds when a PLL is used as in the prior art.

In accordance with an embodiment of the present invention, as shown in FIG. 4, it is possible to overcome problems such as distortion of the PWM signal or jitter due to noise by making a signal including errors such as PWM_1 into PWM_2 of FIG. 4 in the signal compensating unit 30 and averaging the up pulse durations or the duty ratios of this PWM_2 over several cycles.

Again, the synchronization unit 50 will be specifically described with reference to FIG. 1. The synchronization unit 50 synchronizes the signal compensated by the signal compensating unit 30 with an external clock signal to output a synchronized PWM control signal for dimming control. At this time, a frequency of the PWM control signal is determined according to a frequency of the external clock signal. Further, the frequency of the external clock signal may be equal to a frequency of the reference signal.

Referring to FIG. 4, it is possible to synchronize with the external clock signal without using the PLL as in the prior art by synchronizing the signal compensated by the signal compensating unit 30, that is, the PWM_2 signal of which the duty ratios or the up pulse durations is averaged, with a Vsync signal as the external clock signal to output a PWM_IN signal as the PWM control signal. At this time, the PWM_2 signal averaged during the preset cycle, that is, more specifically, the up pulse duration value is output according to a rising edge of the Vsync clock as the external clock signal. At this time, after the external clock signal Vsync previously passes a predetermined number of cycles during the averaging of the duty ratio or the up pulse duration, the averaged PWM_2 signal is synchronized according to the rising edge of the external clock signal Vsync. In an example, after the external clock signal Vsync passes about 3 to 5 cycles for averaging the duty ratios or the up pulse durations of the PWM_2 signal, the averaged PWM_2 signal is synchronized according to the rising edge of the external clock signal Vsync. In an example, since the averaging delay time of this PWM_2 signal is just about 300 ms, it is much shorter than the case that the delay time for preventing flickering in a transient state lasts to seconds when the PLL is used as in the prior art.

When using the PLL as in the prior art, a transient state exists from an initial state in which a frequency is not synchronized until a time when the frequency is synchronized, that is, for a locking time. In this state, frequency and duty are changed. Accordingly, for example, a flickering phenomenon of an LED of a backlight occurs. On the contrary, in this embodiment, it is possible to overcome this phenomenon by synchronizing the averaged PWM_2 signal with the external clock signal Vsync.

Next, an LED driving device in accordance with a second embodiment of the present invention will be described with reference to the drawings. FIG. 2 is a view roughly showing an LED driving device in accordance with another embodiment of the present invention.

Referring to FIG. 2, an LED driving device in accordance with this embodiment includes a dimming control device 100 and a driving switch 200.

In describing the dimming control device 100, one component of an embodiment of the present invention, embodiments of the above-described dimming control device and FIGS. 1, 3, or/and 4 as well as FIG. 2 will be referred. As described above, the dimming control device 100 includes a PWM signal generating unit 10, a signal compensating unit 30, and a synchronization unit 50. A detailed description of the dimming control device 100 will be omitted since it duplicates the above-described embodiments.

Next, the driving switch 200 of FIG. 2 will be described. The driving switch 200 performs a switching operation according to a PWM control signal output from the dimming control device 100 and supplies power to an LED according to the switching operation. In an example, the driving switch 200 is a field effect transistor FET. For example, a MOSFET can be used as the driving switch 200.

In accordance with another embodiment of the present invention, the LED driving device may be used in a backlight unit. In accordance with this embodiment, it is possible to overcome a flickering phenomenon of an LED in the LED backlight unit.

Next, a dimming control method in accordance with a third embodiment of the present invention will be described with reference to the drawings.

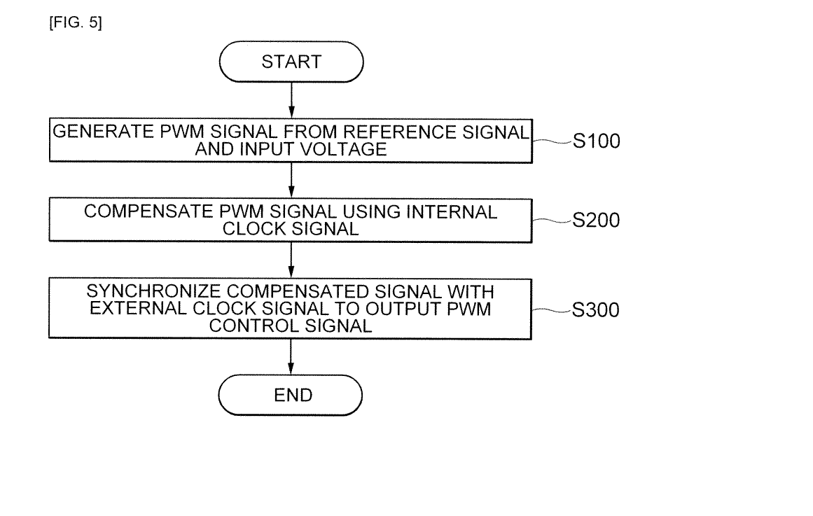

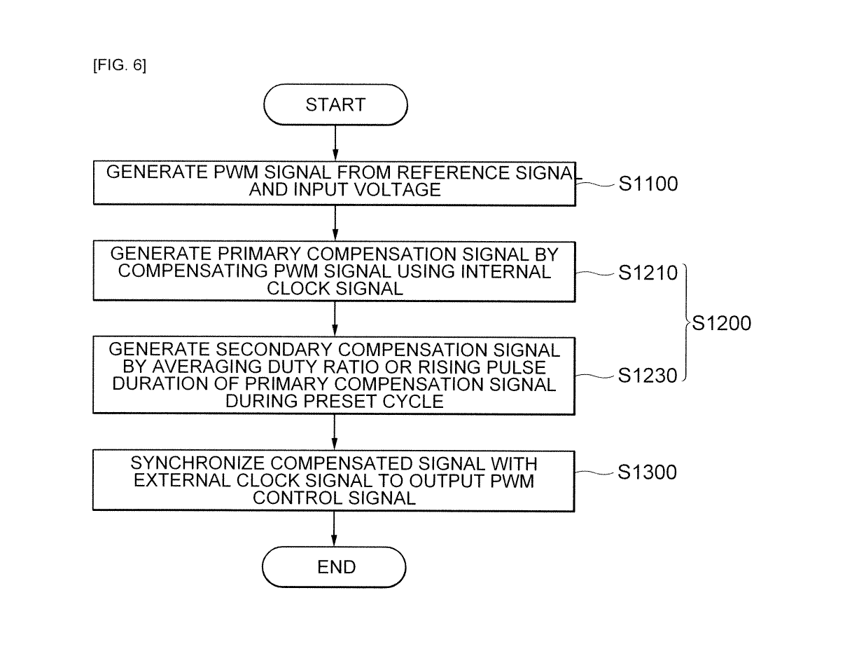

FIG. 5 is a flowchart roughly showing a dimming control method in accordance with yet another embodiment of the present invention. FIG. 6 is a flowchart roughly showing a dimming control method in accordance with still another embodiment of the present invention.

In describing this embodiment, embodiments of the above-described dimming control device and FIGS. 1 to 4 as well as FIGS. 5 and/or 6 will be referred. Accordingly, a description of overlapping parts with the above-described embodiments will be omitted.

Referring to FIGS. 5 or/and 6, a dimming control method in accordance with an embodiment of the present invention includes a PWM signal generating step S100 and S1100, a signal compensating step S200 and S1200, and a synchronization step S300 and S1300.

First, in the PWM signal generating step S100 and S1100, a PWM signal is generated from a reference signal and an input voltage.

At this time, in accordance with another embodiment of the present invention, in the PWM signal generating step S100 and S1100, the PWM signal can be generated by comparing the reference signal generated by a reference signal generating circuit and the input voltage. For example, the PWM signal can be generated by forming a portion of the reference signal, which exceeds the input voltage, as a up pulse and a portion of the reference signal, which does not reach the input voltage, as a falling pulse. At this time, the reference signal may be a triangle wave, a sawtooth wave, and so on. Further, the input voltage may be a DC voltage. In addition to a triangle wave or a sawtooth wave, it is enough that the reference signal is a wave which can implement a pulse wave compared to the input voltage. Further, in addition to a DC voltage, it is also enough that the input voltage is an AC waveform voltage with small amplitude and very low frequency compared to the reference voltage. That is, it is enough that the input voltage is a reference which can generate a pulse wave by comparing a waveform of the reference signal through a comparator and so on.

In another embodiment, the reference signal may be a triangle wave voltage signal or a sawtooth wave voltage signal. At this time, the PWM signal can be generated by generating a up pulse in an interval in which the reference signal is higher than the input voltage. As an example, referring to FIG. 3, the reference signal is a triangle wave, the input voltage is a DC voltage, and the PWM signal can be generated by generating the up pulse in the interval of the triangle wave voltage signal, which is higher than the DC voltage.

Again, referring to FIG. 5, in the signal compensating step S200, the generated PWM signal is compensated by using an internal clock signal. The compensation of the PWM signal is to compensate problems occurring when the PWM signal is generated, for example, influence of interferences such as noise, jitter, and so on.

Furthermore, referring to FIG. 6, in accordance with another embodiment of the present invention, the signal compensating step S1200 may include a primary compensation signal generating step S1210 and a secondary compensation signal generating step S1230.

At this time, in the primary compensation signal generating step S1210, a primary compensation signal is generated by compensating the PWM signal using the internal clock signal. For example, the primary compensation signal, which is generated by compensating the PWM signal using the internal clock signal, may be a compensation signal, which is generated by removing noise included in the PWM signal. For example, it is possible to remove high frequency pulses in the vicinity of pulse rise or/and fall of the PWM signal PWM_1.

More specifically, in accordance with another embodiment, in the primary compensation signal generating step S1210, the primary compensation signal can be generated by counting the number of clocks of the internal clock signal during the up pulse of the PWM signal, determining the up pulse as an effective clock pulse when the counted number is greater than or equal to a preset value, and removing the up pulse when the counted number is less than the preset value. At this time, the internal clock signal INT_CLK uses a frequency much higher than that of the generated PWM signal or the reference signal so that a sufficient number of internal clocks can be counted during the up pulse of the PWM signal. Accordingly, it is possible to obtain a PWM_2 signal of FIG. 4 as the primary compensation signal, which is generated by removing the high frequency pulses in the vicinity of the pulse rise and/or fall of PWM_1.

Further, continuously, referring to FIG. 6, in the secondary compensation signal generating step S1230, a secondary compensation signal can be generated by averaging duty ratios or up pulse (high interval) durations of the primary compensation signal during preset cycles. Referring to FIG. 4, the secondary compensation signal can be generated by averaging the duty ratios or the up pulse durations of the preceding four PWM_2 pulses. At this time, the duty ratio can be represented as the up pulse duration with respect to a cycle (T) time. In an example, since the cycle may be changed due to jitter interference and so on, the secondary compensation signal is generated by averaging the up pulse duration of the PWM_2 signal. The preset cycle number for averaging the duty ratio or the up pulse duration of the PWM_2 signal as the primary compensation signal may be changed according to embodiments. In an example, it may be determined in the range of about 3 to 5 cycles.

Again, referring to FIG. 5 or/and 6, in the synchronization step S300 and S1300, a synchronized PWM control signal for dimming control is output by synchronizing the compensated signal with an external clock signal. At this time, a frequency of the PWM control signal is determined according to a frequency of the external clock signal.

Referring to FIG. 4, it is possible to synchronize with the external clock signal without using a PLL as in the prior art by synchronizing the PWM_2 signal of which the duty ratio or the up pulse (high interval) duration is averaged with a Vsync signal as the external clock signal to output a PWM_IN signal as the PWM control signal. At this time, the PWM_2 signal averaged during the preset cycle, that is, more specifically, the up pulse duration value is output according to a rising edge of the Vsync clock as the external clock signal. In an example, after the external clock signal Vsync passes about 3 to 5 cycles for averaging the duty ratios or the up pulse durations of the PWM_2 signal, the averaged PWM_2 signal is synchronized according to the rising edge of the external clock signal Vsync.

In accordance with an embodiment of the present invention, it is possible to prevent or reduce problems occurring when an internal PWM signal is generated, for example, a malfunction due to clock jitter or/and noise interferences, and it is possible to synchronize with an external clock without using a PLL mainly used in the prior art.

That is, in accordance with an embodiment of the present invention, it is possible to reduce distortion of the PWM signal due to noise by compensating the generated PWM signal.

Further, since there is no PLL block, it is possible to simplify configuration of an internal dimming circuit and overcome a flickering phenomenon caused by using of the PLL.

It is apparent that various effects which have not been directly mentioned according to the various embodiments of the present invention can be derived by those skilled in the art from various constructions according to the embodiments of the present invention.

The above-described embodiments and the accompanying drawings are provided as examples to help understanding of those skilled in the art, not limiting the scope of the present invention. Therefore, the various embodiments of the present invention may be embodied in different forms in a range without departing from the essential concept of the present invention, and the scope of the present invention should be interpreted from the invention defined in the claims. It is to be understood that the present invention includes various modifications, substitutions, and equivalents by those skilled in the art.

What is claimed is:

1. A dimming control device comprising:
a PWM signal generating unit for generating a pulse width modulation (PWM) signal from a reference signal and an input voltage;
a signal compensating unit for compensating the PWM signal output from the PWM signal generating unit using an internal clock signal; and
a synchronization unit for synchronizing the compensated signal with an external clock signal to output a synchronized PWM control signal for dimming control.

2. The dimming control device according to claim 1, wherein the signal compensating unit generates a primary compensation signal by compensating the PWM signal using the internal clock signal and a secondary compensation signal by averaging duty ratios or up pulse durations of the primary compensation signal during preset cycles.

3. The dimming control device according to claim 2, wherein the signal compensating unit generates the primary compensation signal by counting the number of clocks of the internal clock signal during a up pulse of the PWM signal, determining the up pulse as an effective clock pulse when the counted number is greater than or equal to a preset value, and removing the up pulse when the counted number is less than the preset value.

4. The dimming control device according to claim 1, wherein the PWM signal generating unit generates the PWM signal by using a comparator for comparing the reference signal generated by a reference signal generating circuit and the input voltage.

5. The dimming control device according to claim 4, wherein the reference signal is a triangle or sawtooth wave voltage signal.

6. An LED driving device comprising:
a dimming control device according to claim 1; and
a driving switch for performing a switching operation according to the PWM control signal output from the dimming control device and supplying power to an LED according to the switching operation.

7. An LED driving device comprising:
a dimming control device according to claim 2; and
a driving switch for performing a switching operation according to the PWM control signal output from the dimming control device and supplying power to an LED according to the switching operation.

8. An LED driving device comprising:
a dimming control device according to claim 3; and
a driving switch for performing a switching operation according to the PWM control signal output from the dimming control device and supplying power to an LED according to the switching operation.

9. An LED driving device comprising:
a dimming control device according to claim 4; and
a driving switch for performing a switching operation according to the PWM control signal output from the dimming control device and supplying power to an LED according to the switching operation.

10. An LED driving device comprising:
a dimming control device according to claim 5; and
a driving switch for performing a switching operation according to the PWM control signal output from the dimming control device and supplying power to an LED according to the switching operation.

11. The LED driving device according to claim 6, wherein the LED driving device is used in a backlight unit.

12. A dimming control method comprising:
a PWM signal generating step of generating a PWM signal from a reference signal and an input voltage;
a signal compensating step of compensating the generated PWM signal using an internal clock signal; and
a synchronization step of synchronizing the compensated signal with an external clock signal to output a synchronized PWM control signal for dimming control.

13. The dimming control method according to claim 12, wherein the signal compensating step comprises:
generating a primary compensation signal by compensating the PWM signal using the internal clock signal; and
generating a secondary compensation signal by averaging duty ratios or up pulse durations of the primary compensation signal during preset cycles.

14. The dimming control method according to claim 13, wherein in generating the primary compensation signal, the primary compensation signal is generated by counting the number of clocks of the internal clock signal during a up pulse of the PWM signal, determining the up pulse as an effective clock pulse when the counted number is greater than or equal to a preset value, and removing the up pulse when the counted number is less than the preset value.

15. The dimming control method according to claim 12, wherein in the PWM signal generating step, the PWM signal is generated by comparing the reference signal generated by a reference signal generating circuit and the input voltage.

16. The dimming control method according to claim 15, wherein the reference signal is a triangle or sawtooth wave voltage signal, and in the PWM signal generating step, the PWM signal is generated by generating the up pulse in an interval in which the reference signal is higher than the input voltage.
